(19) United States
(12) Patent Application Publication
(10) Pub. No.: US 2023/0142768 A1
(43) Pub. Date: May 11, 2023

(54) PREVENTING CONTRAST EFFECT EXPLOITATION IN ITEM RECOMMENDATIONS

(71) Applicant: Adobe Inc., San Jose, CA (US)

(72) Inventors: Georgios Theocharous, San Jose, CA (US); Michele Saad, Austin, TX (US); Christopher Nota, Hadley, MA (US)

(21) Appl. No.: 17/522,270

(22) Filed: Nov. 9, 2021

(51) Int. Cl. G06Q 30/06; G06K 9/62

(52) U.S. Cl. CPC G06Q 30/0629; G06Q 30/0631; G06K 9/6215

(57) ABSTRACT

An item recommendation system receives a set of recommendable items and a request to select, from the set of recommendable items, a contrast group. The item recommendation system selects a contrast group from the set of recommendable items by applying a recommendation model to the set of recommendable items. The recommendation model includes an item selection model configured to determine an unbiased conversion rate for each item of the set of recommendable items and select a recommended item from the set of recommendable items having a greatest unbiased conversion rate. The recommendation model includes a contrast group selection model configured to select, for the recommended item, a contrast group comprising the recommended item and one or more contrast items. The item recommendation system transmits the contrast group responsive to the request.

### TECHNICAL FIELD

This disclosure generally relates to machine learning techniques for item recommendations. More specifically, but not by way of limitation, this disclosure relates to machine learning models for selecting contrast groups that include a recommended item.

### BACKGROUND

Recommendation systems, such as those used in e-commerce online computing environments, often present recommended items within a contrast group that includes the recommended item and one or more contrast items. Contrast items are items that are similar to or have certain features in common with a recommended item and are presented for the purpose of allowing the user to compare and contrast the recommended item with the contrast items. Presenting a recommended item with contrast items may increase a probability of a user interaction with the recommended item. This increase to the probability of user interaction with the recommended item is called a contrast effect. The contrast effect results from a tendency for user evaluations of items to be influenced by contrasting items. For example, when presented with a contrast group that includes a recommended item and a number of contrast items, users may avoid a contrast item having a high value and a contrast item having a lowest value and select the recommended item, which has a median value. Because recommendation systems often show users a set of recommendations instead of just a single recommendation, contrast effects are often exploited. Exploiting the contrast effect through the use of contrast groups may induce a user to interact with a recommended item in instances where the same user would not have interacted with the item if the user was presented with the recommended item alone. Accordingly, using conventional models for recommending items to a user can increase a a rate of user interaction with items recommended by the system but also result in exploitation of users through contrast effects.

### SUMMARY

The present disclosure describes techniques for using an item recommendation system to receive a set of recommendable items and a request to select, from the set of recommendable items, a contrast group. The contrast group comprises a recommended item and one or more contrast items. The item recommendation system selects the contrast group from the set of recommendable items by applying a recommendation model to the set of recommendable items. The recommendation model includes an item selection model configured to determine an unbiased conversion rate for each item of the set of recommendable items and select a recommended item from the set of recommendable items having a greatest unbiased conversion rate. The recommendation model includes a contrast group selection model configured to select, for the recommended item, a contrast group comprising the recommended item and one or more contrast items. The item recommendation system transmits the contrast group responsive to the request.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for determining, from a set of recommendable items for a user session, a contrast group that minimizes a contrast effect on conversion, according to certain embodiments disclosed herein.

FIG. 2 depicts an example of a process for determining, from a set of recommendable items for a user session, a contrast group that minimizes a contrast effect on conversion, according to certain embodiments disclosed herein.

FIG. 3 depicts an example illustration of a recommendation model for implementing certain embodiments disclosed herein.

FIG. 4 depicts an example of a process for training a recommendation model, according to certain embodiments disclosed herein.

FIG. 5 depicts example illustrations of a contrast effect on recommendable items, according to certain embodiments disclosed herein.

FIG. 6 depicts an example illustration of selection of a contrast group for a recommended item, according to certain embodiments disclosed herein.

FIG. 7 depicts an example of a computing system that performs certain operations described herein, according to certain embodiments described in the present disclosure.

FIG. 8 an example of a cloud computing system that performs certain operations described herein, according to certain embodiments described in the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

Certain embodiments described herein address the limitations of conventional e-commerce systems by providing a machine learning model to automatically determining, from a set of recommendable items for a user session, a contrast group that maximizes a conversion rate and minimizes a contrast effect, wherein the determined contrast group can be used for modifying online e-commerce computing environments or other systems. An e-commerce system is typically a network-based computing system including network-connected servers configured to offer goods and/or services (e.g. via e-commerce websites mobile applications or other means) of e-commerce merchants, where end users (e.g., consumers) can interact with the servers using network-connected computing devices (e.g. personal computers and mobile devices) to browse, purchase, or otherwise interact with the presentation of goods and/or services offered by the e-commerce merchants. Many different entities may connect to the network and participate in the e-commerce environment. For example, advertisers, data analytics services, suppliers, distributors and other service providers may all operate servers and/or other computing devices connected to the network for interacting with the end users, the e-commerce merchants and/or each other.

With reference to the embodiments described herein, an e-commerce environment may include a recommendation system operated by or on behalf of an e-commerce merchant. A recommendation system in this context is a computing device configured to interact with various databases to access data regarding products and/or services that may be relevant to a user's search request. The recommendation system may be configured to provide information regarding a most relevant item responsive to the user's request and to recommend other items that may be of interest to the user. Certain embodiments described herein improve the performance of conventional item recommendation systems used in e-commerce systems by, for example providing item and contrast group recommendations that reduce a contrast effect without harming a performance of a recommendation system with respect to a rate or number of expected conversions.

The following non-limiting example is provided to introduce certain embodiments. In this example, an item recommendation system implementing a recommendation model receives input data including a set of recommendable items and a request for a contrast group including a recommended item and one or more contrast items. The input data may be received from a shopping system (e.g. a merchant website) and the set of recommendable items could be a set of items in an inventory of the shopping system. The item recommendation system determines a contrast group that minimizes a contrast effect on conversion. The contrast group includes the recommended item and selected contrast items. For example, the item recommendation system receives a set of recommendable items (e.g. a set of items of a merchant website, a set of search results) and a request for a contrast group for a user session (e.g. a shopping session, an advertisement session, a search session). The item recommendation system applies a recommendation model to the set of recommendable items to determine a contrast group including a recommended item and one or more contrast items. In some examples, the recommendation model includes an item selection model and a contrast group selection model. The item selection model is configured to select, from the set of recommendable items, a recommended item having a greatest unbiased conversion rate. For example, the unbiased conversion rate is an expected conversion rate for an item without any contrast effect from presenting the item within a contrast group. The contrast group selection model is configured to select a contrast group that includes the recommended item and one or more contrast items. The contrast group comprises the combination of contrast items and the recommended item that is predicted to provide for a greatest probability of conversion for the recommended item.

Continuing with this example, the item recommendation system transmits the contrast group, including the recommended item and the one or more contrast items, to the system from which the request for the contrast group was received. In this example, the system that requested the contrast group is a shopping system. In some embodiments, the item recommendation system, or the system to which the contrast group is transmitted, modifies features of an online computing environment based on the contrast group selection associated with a user session. In some instances, modifying the features of the online computing environment include presenting the contrast group to a user associated with the user session, or otherwise performing an action with respect to the user session associated with the request for the contrast group.

In certain embodiments, during a training phase, the recommendation model is trained to select a contrast group for a set of recommendable items. In an example, the recommendation model is trained using reinforcement learning. For example, the recommendation model is iteratively applied to a training data set to determine contrast groups from sets of recommendable items. Each time a contrast group is selected, the recommendation model receives a reinforcement value depending on whether presentation of the contrast group causes a conversion (e.g. a purchase, a click, or other desired outcome in the user session associated with the determination of the contrast group). At each iteration, one or more parameters of the recommendation model may be modified based on the received reinforcement value.

The recommendation model that determines contrast groups for sets of recommendable items, described herein, provides several improvements and benefits over conventional techniques. For example, the conventional techniques discussed above focus exclusively on providing contrast group recommendations that provide for a maximum conversion rate though exploitation of contrast effect, even when recommended items would otherwise likely not meet a target users' needs and be converted. The recommendation model described herein can reduce a contribution of the user-exploitative contrast effect toward a conversion rate while also not sacrificing the conversion rate. Therefore, the contrast group recommendations provided by the recommendation model described herein are more accurate to target users' needs while not sacrificing the effectiveness of recommendations.

As used herein, the term “recommended item” is used to refer to item that the item recommendation system recommends to a user. In certain examples, a recommended item is presented to a user via a user interface. In certain examples, the recommended item is presented in an advertisement, on a product page of an on-line shopping website, or on another user interface.

As used herein, a “conversion” refers to an interaction with recommended item logged by the item recommendation system. The item recommendation system defines, as a conversion, an interaction with the recommended item, such as a purchase, a selection, an addition to a wishlist, an addition to an online shopping cart, a click, a hover, or other interaction with the recommended item.

As used herein, the term “unbiased conversion rate” or “unbiased conversion probability” is used to refer to probability of conversion of a recommended item if the recommended item is presented alone and not presented or displayed along with other items. In some instances, when a recommended item is presented alone, a user's decision to click, add to an online shopping cart, purchase, or otherwise interact with the recommended item via a user interface will not be biased or influenced as it may be if other items were presented to the user in the user interface at the same time.

As used herein, the term “contrast effect” is used to refer to a change in a conversion probability or conversion rate of a recommended item when the recommended item is recommended along with other items. For example, presenting a recommended item along with other items may inject conscious or unconscious biases to a user's decision-making process regarding whether to click the recommended item, add the recommended item to a shopping cart, or otherwise interact with the recommended item in the user interface.

As used herein, the term “contrast items” refer to items that are recommended along with a recommended item. Contrast items may be similar to the recommended item but have one or more different features. For example, the recommended item is a pack of three pairs a particular brand and style of socks and two contrast items include a single pair of the same brand/style of socks and a pack of ten pairs of the same brand/style of socks.

As used herein, the term “contrast group” is used to refer to a group of items that includes a recommended item and one or more contrast items. Due to the contrast effect, presenting a recommended item within a contrast group may increase a probability of conversion (e.g. a purchase, a click, etc.) of the recommended item compared to presenting the recommended item alone.

Example Operating Environment for Determining a Contrast Group from a Set of Recommendable Items

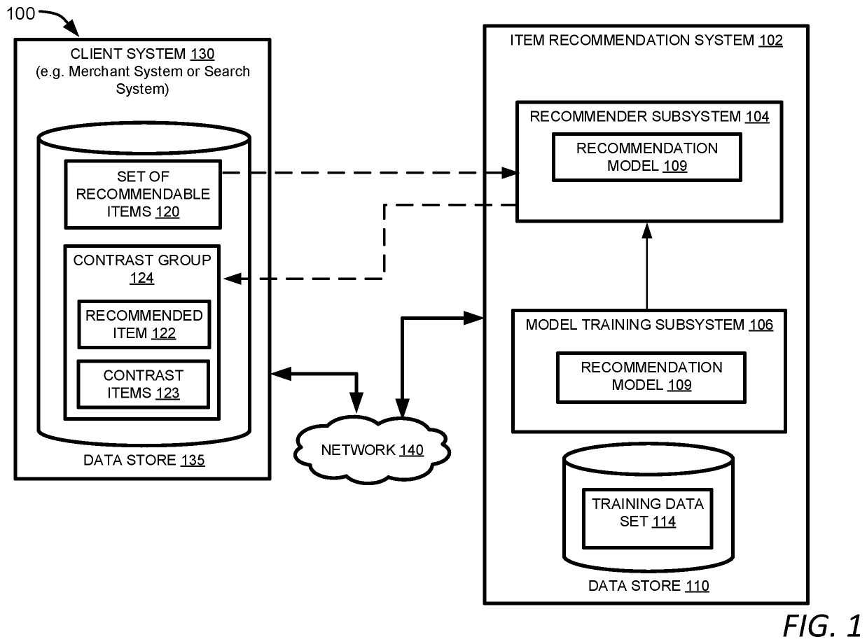

Referring now to the drawings, FIG. 1 depicts an example of a computing environment 100 for determining, by an item recommendation system 102 from a set of recommendable items 120, a contrast group 124 including a recommended item 122 and contrast items 123. The computing environment 100 includes an item recommendation system 102, which can include one or more processing devices that execute a recommender subsystem 104. In certain embodiments, the item recommendation system 102 is a network server or other computing device connected to a network 140. The recommender subsystem 104 applies a recommendation model 109 to a set of recommendable items 120 received from a client system 130 (e.g. a merchant system, a search system, a merchant webserver, a computing system used by an e-commerce service provider, or other client system) to determine a contrast group 124 that includes a recommended item 122 and contrast items 123. For example, the set of recommendable items 120 are retrieved by the client system 130 from a data store 135 of the client system 130 and the client system 130 transmits the set of recommendable items 120 to the item recommendation system 102. The one or more processing devices of the item recommendation system 102 can further execute a model training subsystem 106 for training the recommendation model 109 that is used for selecting the contrast group 124. The item recommendation system 102 transmits the selected contrast group 124 to the client system 130 via the network 140 and the client system 130 stores the contrast group 124 in the data store 135. The computing environment 100 further includes a data store 110 for storing data used in the determination of the contrast group 124 prediction, such as the training data set 114.

The recommender subsystem 104 and the model training subsystem 106 may be implemented using software (e.g., code, instructions, program) executed by one or more processing units (e.g., processors, cores), hardware, or combinations thereof. The software may be stored on a non-transitory storage medium (e.g., on a memory device). The computing environment 100 depicted in FIG. 1 is merely an example and is not intended to unduly limit the scope of claimed embodiments. One of the ordinary skill in the art would recognize many possible variations, alternatives, and modifications. For example, in some implementations, the item recommendation system 102 can be implemented using more or fewer systems or subsystems than those shown in FIG. 1, may combine two or more subsystems, or may have a different configuration or arrangement of the systems or subsystems.

The recommender subsystem 104 is configured to receive or otherwise access a set of recommendable items 120. In some instances, the set of recommendable items 120 is provided to the recommender subsystem 104 by a client system 130 (e.g. a search system, a merchant shopping system, etc.). In other instances, the item recommendation system 102 determines the set of recommendable items 120 from a set of items, for example, a set of items stored in the data store 135 of the client system 130. For example, the item recommendation system 102 could determine the set of recommendable items from an item directory of the client system 130 based on a context vector of a user. The set of recommendable items 120 could be a set of items in an inventory of a merchant website. In certain embodiments, the set of recommendable items 120 is determined based on a context vector of a user session (e.g. a shopping session or other session in which a contrast group is to be presented), which includes information about a user and about a current browsing session of the user.

In some instances, the item recommendation system 102 receives a request to provide a contrast group 124 including a recommended item 122 and one or more contrast items 123, the request including the set of recommendable items 120. In some instances, the recommendation system 102 receives the request from the client system 130 via the network 140. The client system 130 may transmit the request to determine the contrast group 124 (including the recommended item 122 and contrast items 123) along with identifiers identifying each of the set of recommendable items 120. In other examples, the recommendation system 102 can retrieve, responsive to receiving the request, the set of recommendable items 120 associated with the identifiers from a database, for example, from the data store 135 of the client system 130. The recommendation system 102 can retrieve, for example from the data store 135, one or more features associated with each item of the set of recommendable items 120 or otherwise receive, from the client system 130, information including the one or more features. Features can include item name, item description, item category and subcategory/subcategories, price, quantity, weight, an image and associated data, or other features associated with an item.

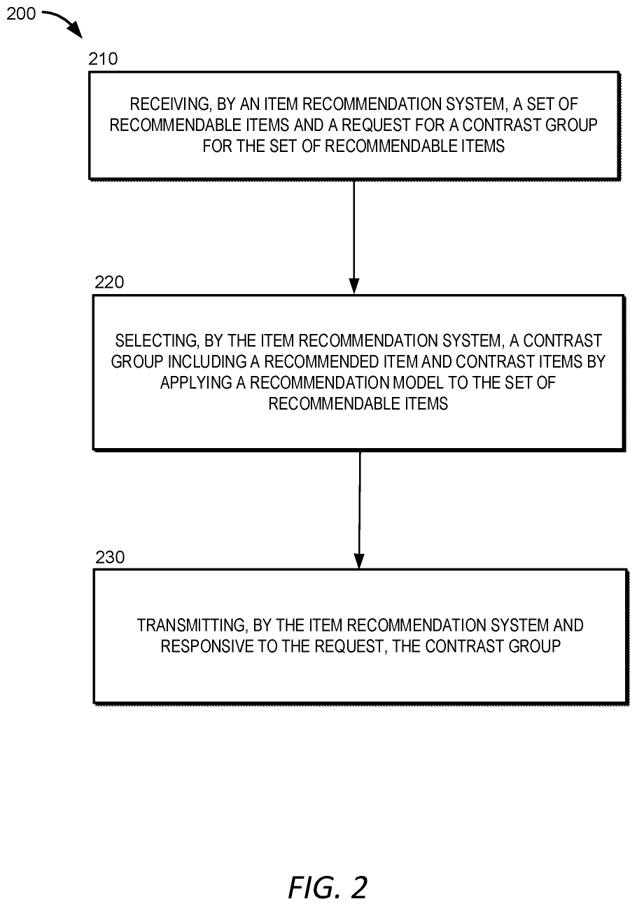

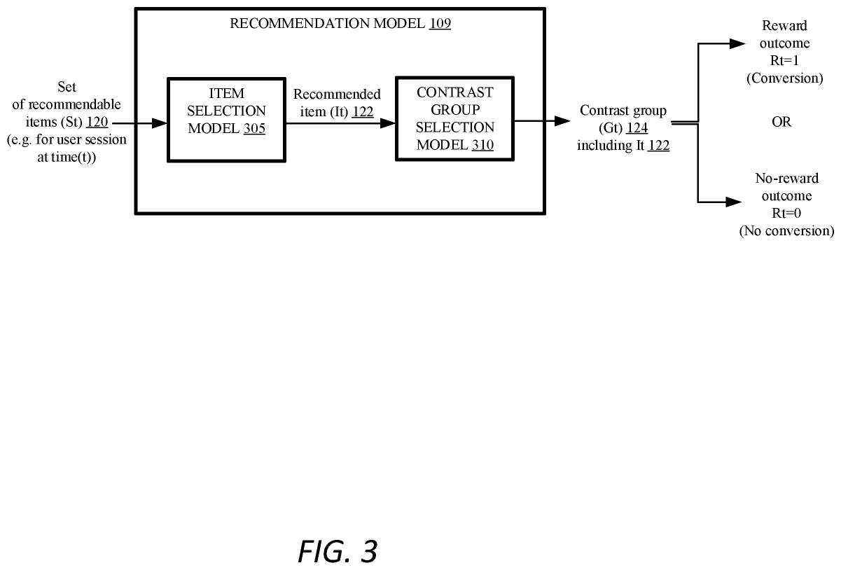

To determine the contrast group 124, including the recommended item 122 and contrast items 123, the item recommendation system 102 employs a recommendation model 109. Additional details about determining the contrast group 124 by applying a trained recommendation model 109 are provided below with respect to FIG. 2. Additional details about the recommendation model 109 are provided below with respect to FIG. 3. In certain examples, the item recommendation system 102 includes a request module configured to receive a set of recommendable items and a request to select, from the set of recommendable items, a group of items. In certain examples, the item recommendation system 102 includes a biased conversion rate prediction module that is configured to determine, for each item in a set of recommendable items 120, a biased conversion rate. In certain examples, the item recommendation system 102 includes an unbiased conversion rate prediction module that is configured to determine for each item in a set of recommendable items 120, an unbiased conversion rate. In certain examples, the item recommendation system 102 includes an item selection module that is configured to select the recommended item 122 from among the set of recommendable items 120. In these examples, the recommended item 122 selected by the item selection module has a highest unbiased conversion rate of the set of recommendable items 120. In certain examples, the item recommendation system 102 includes a contrast group selection module configured to select, for the recommended item 122, from among a set of possible contrast groups that include the recommended item 122, a contrast group that will provide a greatest predicted conversion rate for the recommended item 122. For example, the contrast group selection module determines, from the set of recommendable items, a set of possible contrast groups that include the recommended item. In this example, the contrast group selection module determines, for each possible contrast group of the set of possible contrast groups, a conversion rate for the recommended item when placed in the possible contrast group. In this example, the contrast group selection module selects a possible contrast group of the set of possible contrast groups having a greatest conversion rate for the recommended item, wherein the selected contrast group comprises the selected possible contrast group.

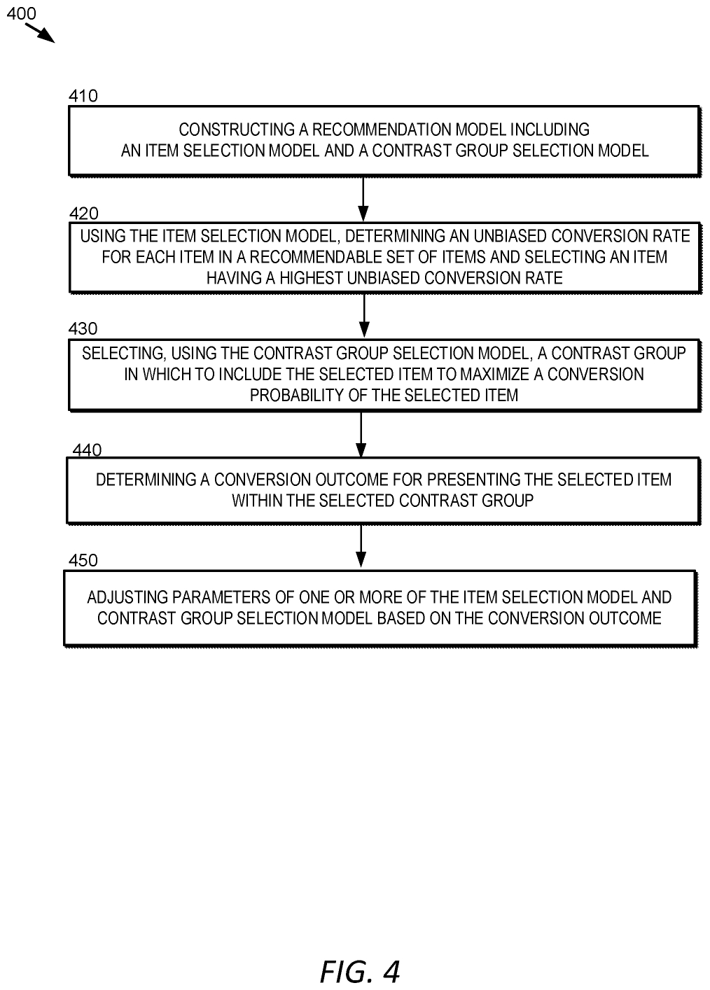

The item recommendation system 102 determines and trains the recommendation model 109 using the model training subsystem 106. The model training subsystem 106 builds and trains the recommendation model 109. The model training subsystem 106, using the training data set 114, trains the recommendation model 109 using a reinforcement learning process. Additional details of determining and training a recommendation model 109 is described in FIG. 4. In various examples, the model training subsystem 106 can be implemented as one or more of program code, program code executed by processing hardware (e.g., a programmable logic array, a field-programmable gate array, etc.), firmware, or some combination thereof.

Examples of Computer-Implemented Operations for Determining a Contrast Group for a Set of Recommendable Items

FIG. 2 depicts an example of a process for using a recommendation model 109 to determine a contrast group 124, including a recommended item 122 and contrast items 123, for a set of recommendable items 120. One or more computing devices (e.g., the item recommendation system 102 or the individual modules contained therein) implement operations depicted in FIG. 2. For illustrative purposes, the process 200 is described with reference to certain examples depicted in the figures. Other implementations, however, are possible.

At block 210, the method 200 involves receiving a set of recommendable items 120 and a request to determine a contrast group 124 for the set of recommendable items 120. In an embodiment, the client system 130 (e.g. a shopping system, a search system) selects the set of recommendable items 120 based on a context vector for a user session (e.g. a shopping session, a search session) and transmits the set of recommendable items 120 to the item recommendation system 102 via the network 140. In other examples, the item recommender system 102 selects the set of recommendable items 120 based on the context vector for the user session. The context vector is based on user profile features of a user of the session, a browsing history or interaction history for the session, location data of the user, or other information of a user associated with the user session. For example, in a user session, the user is browsing a merchant shopping website and the merchant website is configured to present contrast groups 124 of items to the user in response to receiving inputs from the user via the website. In this example, the merchant website requests for the item recommendation system 102 to determine contrast groups 124 for the user session at one or more time points during the user session. The set of recommendable items 120 could include a set of items offered for sale on a merchant website, a set of search results for presentation to a user by a search system, or other set of items. In some instances, the set of recommendable items 120 include, for each of item of the set of recommendable items 120, one or more features. Features can include item name, item description, item category and subcategory/subcategories, price, quantity, weight, an image and associated data, a click-through rate, a conversion rate, or other quantitative or categorical features associated with an item. In certain examples, the request module of item recommendation system 102 is configured to receive a set of recommendable items and a request to select, from the set of recommendable items, a group of items.

At block 220, the method 200 involves determining, by the item recommendation system 102, a contrast group 124 including a recommended item 122 and contrast items 123 by applying a recommendation model 109 to the set of recommendable items 120. In some embodiments, the recommendation model 109 determines a set of features for each item of the set of recommendable items 120. The recommendation model 109 determines, for each item of the set of recommendable items and based on the set of features for each item of set of recommendable items 120, a biased conversion rate for each possible item to contrast group pair. In certain examples, the item recommendation system 102 includes a biased conversion rate prediction module that is configured to determine, for each item in a set of recommendable items 120, a biased conversion rate. The biased conversion rate is determined as a function of a distance score and learnable weight vector, which is shared between all items and groups within the set of recommendable items 120, and a learnable item-dependent scalar, which is specific to each item in the set of recommendable items 120. The distance score measures a similarity of items in a contrast group and is determined based on features of each item in the contrast group. The recommendation model 109, based on the biased conversion rate determined for each item to contrast group pairing for the set of recommendable items 120, extrapolates an unbiased conversion rate for the item using an upper confidence bound algorithm and selects a recommended item 122, from the set of recommendable items 124, that has a highest unbiased conversion rate.

For example, the recommendation model 109 determines, for each item of the set of recommendable items 120, biased conversion rates of the respective item when included within each possible contrast group that includes the respective item. The recommendation model 109 determines, for each possible contrast group that includes the respective item, a distance score based on features of items in the possible contrast group. For example, the distance score for a possible contrast group is determined based on a similarity of feature vectors representing features of items within the respective possible contrast group. In this example, the recommendation model 109 also determines, for each item of the set of recommendable items, a set of biased conversion rates representing a conversion rate of the item when placed within each of the possible contrast groups. The recommendation model 109 determines the unbiased conversion rate for each item of the set of recommendable items 120 by (1) determining a function that explains the biased conversion rate as a function of the distance score of the respective possible contrast group that includes the item and (2) determining an output of the function at a distance score of zero. For example, a distance score of zero represents a hypothetical contrast group in which all of the items are the recommended item 122. In this example, the hypothetical contrast group is equivalent to the recommended item 122 being presented alone without being placed within a contrast group. In certain examples, the item recommendation system 102 includes an unbiased conversion rate prediction module that is configured to determine for each item in a set of recommendable items 120, an unbiased conversion rate. In certain examples, the unbiased conversion rate prediction module is configured to determine, for each possible contrast group of the set of possible contrast groups, a distance score based on features of items of the possible contrast group; and determine, for each item of the set of recommendable items and based on (1) the biased conversion rates for the item and (2) the distance score for each possible contrast group, the unbiased conversion rate for the item. In certain examples, the unbiased conversion rate prediction module is configured to determine a function that explains the biased conversion rate for each item as a function of the distance score of the respective possible contrast group that includes the item, wherein the item selection module determines the unbiased conversion rate using the function. In certain examples, the item recommendation system 102 includes an item selection module that is configured to select the recommended item 122 from among the set of recommendable items 120. In these examples, the recommended item 122 selected by the item recommender module has a highest unbiased conversion rate of the set of recommendable items 120.

The recommendation model 109 determines a contrast group, including the selected recommended item 122 and contrast items 123. The recommendation model 109 determines the recommended item 122 as the item of the set of recommendable items 120 that is predicted to have a greatest unbiased conversion rate. The recommendation model 109 then determines a contrast group 124 that provides for a maximum conversion rate for the selected recommended item 122. For example, the recommendation model 109 selects the recommended item 122 predicted to be the most likely item of the set of recommendable items 120 to lead to a conversion if presented alone (i.e. the recommended item 122 has a greatest unbiased conversion rate of the set of recommendable items 120). The recommendation model then predicts the contrast group 124 that is expected to provide a greatest expected conversion rate (including a contrast effect on the conversion rate that results from the recommended item 122 being placed in the contrast group 124) for the recommended item 122. An illustration of a selection of a contrast group that provides for a greatest expected conversion rate for a recommended item 120 is shown in FIG. 6. In certain examples, the item recommendation system 102 includes a contrast group selection module configured to select, for the recommended item 122, from among a set of possible contrast groups that include the recommended item 122, a contrast group that will provide a greatest predicted conversion rate for the recommended item 122. For example, the contrast group selection module determines, from the set of recommendable items, a set of possible contrast groups that include the recommended item. In this example, the contrast group selection module determines, for each possible contrast group of the set of possible contrast groups, a conversion rate for the recommended item when placed in the possible contrast group. In this example, the contrast group selection module selects a possible contrast group of the set of possible contrast groups having a greatest conversion rate for the recommended item, wherein the selected contrast group comprises the selected possible contrast group.

At block 230, the method 200 involves transmitting, by the item recommendation system 102 and responsive to the request, the contrast group 124. For example, the recommender subsystem 104 transmits contrast group 124, which includes the recommended item 122 and contrast items 123, to the system from which the request to determine the contrast group 124 was received (e.g. the client system 130). In some embodiments, the recommender subsystem stores the contrast group 124 in the data store 110, which is accessible to the client system 130, and the client system 130 accesses the contrast group 124 via the network 140. In some embodiments, the recommendation subsystem 104, or the client system 130 to which the contrast group 124 is transmitted, modifies features of an online computing environment based on the contrast group 124 prediction by the recommendation model 109 for the set of recommendable items 120. In certain examples, the contrast group selection module of the item recommendation system 102 responsive to the request, the contrast group 124 to the system from which the request to determine the contrast group 124 was received (e.g. the client system 130).

In some instances, modifying the features of the online computing environment include presenting, in a user interface (e.g. via a merchant website, via a search system website, via a post of a social media website, etc.) the contrast group 124. One or more user interface objects may be displayed in the user interface to enable selection of the recommended item 122 and/or the contrast items 123 of the contrast group 124. In some instances, a user may interact with the recommended item 122 displayed in the user interface, for example, the user may click, select, hover over, or otherwise interact with a user interface object of the recommended item 122 via the user interface to add the recommended item 122 to an online shopping cart, to request further information about the recommended item 122, add the recommended item 122 to a wish list, like or otherwise react to the recommended item 122 (e.g. where the contrast group 124 is displayed in a social media post), initiate a purchase of the recommended item 122. In these instances, the item recommendation system 102 receives data indicative of a conversion indicating an interaction with the user interface object of the recommended item 122 displayed within the contrast group 124. In other instances, the item recommendation system 102 does not receive data indicative of a conversion or receives data indicating that no conversion happened with respect to the recommended item 122 displayed within the contrast group. The item recommendation system 102 logs a conversion or a non-conversion of the recommended item 122 displayed within the contrast group 124. The item recommendation system 102 can update one or more features of the recommended item 124 based on the logged conversion or logged non conversion, for example, an overall conversion rate for the recommended item 122.

FIG. 3 depicts an illustration of a recommendation model 109 for use in certain embodiments described herein, for example as described in FIG. 1 and FIG. 2. As depicted in FIG. 3, the recommendation model 109 comprises an item selection model 305 and a contrast group selection model 310. A process for training the recommendation model 109 is described in FIG. 4. In certain examples, the recommendation model 109 receives a set of recommendable items 120, as depicted in FIG. 3, for example a set of recommendable items 120 (St) for a user session at time t. In an example embodiment, the recommendation model 109 receives, at each time step t, a set of recommendable items 120, for example, a set of items available on a merchant website to recommend in a user session. In this embodiment, the recommendation model 109 selects a recommended item 122 from the set of recommendable items 120 and a contrast group 124 that includes the recommended item 122 and multiple (e.g. two) contrast items 123. The contrast group 124 is then displayed to the user in the user session. As shown in FIG. 3, if a conversion of the recommended item 122 occurs, the recommendation model 109 receives a reward value (Rₜ) of 1, otherwise, the recommended item 122, the recommendation model 109 receives a reward (Rₜ) of 0 if no conversion occurs. A conversion may be defined by the item recommendation system 102 as a purchase, click, hover, or other user interface interaction with the recommended item 122 when presented in the contrast group 124 to the user in a user interface in the user session. The probability of conversion is:

r(i,g)= [symbol] [Rₜ|Iₜ=i,Gₜ=g] Equation (1),

where r is the conversion probability, i is the recommended item 122 at time t, g is the contrast group 124 recommended at time step t that includes the recommended item 122, Rₜ is the reward value. The goal of the recommendation model 109 is to choose a sequence of policies πₜ that maximizes an expected sum of rewards, Σₜ₌₀^{T} [symbol] [r(Iₜ, Gₜ)|πₜ], where T is a lifetime of the recommendation model 109 (comprised of time steps t). The recommendation model 109 models the conversion rate r(i, g) for a recommended item (i) 122 presented within a contrast group (g) 124 as a sum of two components:

r(i,g)=rᵢ(i)+b(i,g) Equation (2),

where rᵢ(i) is the unbiased conversion rate and b(i, g) and a contrast effect. The unbiased conversion rate represents a probability that a recommended item (i) 122 will be converted (e.g. via user interaction with the recommended item 122 in the user session) if it were displayed alone and not within a contrast group 124. The contrast effect b(i, g) is an impact of a contrast group 124 on a probability of conversion rᵢ(i) of a recommended item 122.

The item selection model 305 determines a recommended item 122 selected from the set of recommendable items 120. For example, the item selection model 305 is configured to determine, for a user session at a time (t) from a set of recommendable items 120 (Sₜ) for the user session at time (t), the recommended item 122 (Iₜ). The recommended item 122 has a greatest unbiased conversion rate of the set of recommendable items 120. The recommendation model 109 constrains a solution according to the following optimization problem (equations 3 and 4):

max [symbol] [b(I,G)|π] Equation (3),

s. t. πϵ arg max [symbol] [rᵢ(I)π′] Equation (4).

Equations 3 and 4 constrain the solution to maximize the unbiased conversion rate rᵢ(I) and then maximize the contrast effect b (I, G), subject to the constraint that maximizes the unbiased conversion rate.

The item selection model 305 is configured to estimate an unbiased conversion rate for each of the set of recommendable items 120 and select the recommendation item 122, which is an item of the set of recommendable items 120 that has a greatest unbiased conversion rate. To determine the unbiased conversion rate for each item of the set of recommendable items 120, the item selection model 305 determines, based on features associated with each item in the set of recommendable items 120, a distance score d, for each item i if it were placed in each possible contrast group g. The distance score d measures a similarity between the respective item and features of items in a contrast group 124. A contrast group 124 could include the item i in addition to two (or three, four, five, or other predetermined number) of contrast items 123. The item selection model 305 models the biased (overall) conversion rate as:

\hat{r}(i,g)=\hat{r}(i)+\hat{b}(d(g)) Equation (5),

where \hat{r}(i) is the unbiased conversion rate and \hat{b}(d(g)) is the contrast effect as a function of distance score d. Accordingly, some function of the distance score d is added to the unbiased conversion rate to determine the biased conversion rate. The item selection model 305 learns the unbiased conversion rate and the contrast effect using least squares regression. Once the item selection model 305 learns functions for the unbiased conversion rate \hat{r}(i) and the contrast effect \hat{b}(d(g)), the item selection model 305 selects a recommended item 122 that gives a maximum unbiased conversion rate, using the function arg max_{iϵI}_{ₜ}\hat{r}(i).

The item selection model 305 uses a basis expansion, ϕ(d(g)) to estimate the (overall) biased conversion rate \hat{r}(i, g), as follows:

\hat{r}(i,g)=w^{T}ϕ(d(g))+rᵢ Equation (6),

where w^{T} is a learnable weight vector, rᵢ is a learnable item-dependent scalar. In some examples, the basis expansion ϕ(d(g)) is a Fourier basis expansion, but other basis expansions may be used. The item selection model 305 uses a upper confidence bound (UCB) algorithm (e.g. a UCB1 algorithm) to minimize the unbiased conversion rate, rather than the standard biased conversion rate. For example, the UCB1 algorithm, at each time step t, selects an item i with a highest upper confidence bound according to:

$$UCB ( i ) = {μ}_{i} + C \sqrt{\frac{2 ln {\sum }_{j ϵ {I}_{t}} {s}_{j}}{{s}_{i}}} , \qquad Equation ( 7 )$$

where μᵢ is an observed conversion rate for item i, Sᵢ is a number of times that item i has been recommended, Iₜ is a set of recommendable items available at time t, and C is a positive constant. In this example of Equation 7, the first term an estimate of the value, and the second term is an exploration bonus where, as time progresses, if item i is not recommended, then the exploration bonus continues to increase. Accordingly, as t goes to infinity, every item will be recommended an infinite number of times and estimates of μᵢ will converge to the true conversion rate by the law of large numbers. In some examples, instead of computing a confidence interval using Hoeffding's inequality, as in UCB1, the item selection model 305 instead computes an uncertainty in a parameter bᵢ for a given confidence interval. By increasing the confidence interval over time, for example, by choosing a confidence level of 1−1/t, the item selection model 305 guarantees that every item is eventually chosen. The item selection model 305 computes the upper confidence bound for the item-dependent parameter rᵢ by computing a t-test-style confidence interval over the regression coefficients, as follows:

$${CI}^{+} ( i , α ) = {r}_{i} + {t}_{1 - α , n - 2} \sqrt{\frac{\frac{1}{n - 2} {\sum }_{t} {( {R}_{t} - \hat{r} ( {I}_{t} , {G}_{t} ) )}^{2}}{{( {x}^{T} x )}_{i , i}^{- 1}}} , \qquad Equation ( 8 )$$

where i is the item number, a is a confidence level, Iₜ is the item chosen at time t, Gₜ is the group chosen at time t, Rₜ is the reward at time t, n is a number of time steps so far, and x is a matrix containing the feature vectors for each time step. The item selection model 305 then selects the recommended item 122 using the function arg max_{iϵI}CI⁺(i, a), which selects the item providing the maximum value for Equation 8.

The contrast group selection model 310 is configured to, given a recommended item 122 selected by the item selection model 305, select a contrast group 124 of items that includes the recommended item 122 and a predetermined number of contrast items 123 (for example, two, three, four, or other predetermined number of contrast items 123). For example, if the set of recommendable items 120 comprises items A, B, C, and D, a predefined contrast group size is three items, and item A is the recommended item 122, then {A, B, C}, {A, C, D}, and {A, B, D} are the possible contrast groups that include recommended item A that could be selected. In certain embodiments, the contrast group selection model 310 applies an algorithm that includes an asymptotic guarantee that each possible contrast group will be chosen infinitely often to ensure that a linear regression converges correctly. In certain embodiments, the contrast group selection model 310 uses a UCB1 algorithm for determining the contrast group 124. In certain embodiments, the item selection model 305 and the contrast group selection model 310 applies an Upper Confidence Bound applied to Trees (UCT) algorithm, where a UCB1 algorithm is used for both recommended item 122 selection and contrast group 124 selection. In certain embodiments, the item selection algorithm is replaced with the following linear regression algorithm approach:

Algorithm 1: Debiased UCB

```
Initialize [symbol]   = { }
foreach episode do
  | iₜ = argmaxᵢCI⁺ ( [symbol]  , i, αₜ);
  | gₜ = choosegroup(iₜ);
  | dₜ = distance(gₜ);
  | rₜ = recommend(gₜ);
  | [symbol]   ← (iₜ, dₜ, rₜ);
  | t = t + 1;
end foreach
```

Some implementations of Algorithm 1 may control an extent to which the contrast group selection model 310 exploits contrast effects. For example, the contrast group selection model 310 can be configured to minimize effects of contrast bias when the cost (in terms of a biased regret) is low, but not when the cost is a large number of sales. To achieve this minimization of contrast bias, the contrast group selection model 310 can use an adjustable exploitation parameter, βϵ[0,1], which trades off between biased and debiased algorithms, where β=0 is equivalent to the debiased UCB and β=1 is equivalent to the standard UCB. The algorithm uses a weighted average of the debiased and standard confidence bounds, with the adjustable exploitation parameter β determining the weight on each of the confidence bounds. For example, at each time step, the contrast group selection model 310 chooses:

argmax((β)UCB+(1−β)CI⁺(i,α)) Equation (9),

where UCB(i) is defined by Equation 7 and CI⁺ by Equation 8.

FIG. 4 depicts an example of a process 400 for training a recommendation model, according to certain embodiments disclosed herein. One or more computing devices (e.g., the item recommendation system 102 or the model training subsystem 106) implement operations depicted in FIG. 4. For illustrative purposes, the process 400 is described with reference to certain examples depicted in the figures. Other implementations, however, are possible.

At block 410, the method 400 involves constructing a recommendation model 109 including an item selection model 305 and a contrast group selection module 310. The item selection model 305 is configured to select, from a set of recommendable items 120, a recommended item 122 having a greatest unbiased conversion rate of the set of recommendable items 120. The contrast selection model 310 is configured to select, given the selected recommended item 122, a contrast group 124 that includes the recommended item 122 and contrast items 123. In certain embodiments, the contrast group 124 is selected to maximize a conversion rate of the selected recommended item 122. Examples of the recommendation model 109 are described in FIG. 1 and FIG. 3 herein.

At block 420, the method 400 involves determining, using the item selection model 305, an unbiased conversion rate for each item in a recommendable set of items 120 and selecting a recommended item 122 having a highest unbiased conversion rate. The recommendation model 109 determines, for each item of the set of recommendable items and based on the set of features for each item of set of recommendable items 120, a biased conversion rate for each possible item to contrast group pairing. The biased conversion rate is determined as a function of a distance score and learnable weight vector, which is shared between all items and groups within the set of recommendable items 120, and a learnable item-dependent scalar, which is specific to each item in the set of recommendable items 120. The distance score measures a similarity of items in a contrast group and is determined based on features of each item in the contrast group. The recommendation model 109, based on the biased conversion rate determined for each item for the set of recommendable items 120, extrapolates an unbiased conversion rate using an upper confidence bound algorithm and selects a recommended item 122, from the set of recommendable items 124, that has a highest unbiased conversion rate.

The item selection model 305 is configured to estimate an unbiased conversion rate for each of the set of recommendable items 120 and select the recommendation item 122, which is an item of the set of recommendable items 120 that has a greatest unbiased conversion rate. To determine the unbiased conversion rate for each item of the set of recommendable items 120, the item selection model 305 determines, based on features associated with each item in the set of recommendable items 120, a distance score d, for each item i if it were placed in each possible contrast group g. The distance score d measures a similarity between the respective item and features of items in a contrast group 124. A contrast group 124 could include the item i in addition to two (or three, four, five, or other predetermined number) of contrast items 123. The item selection model 305 models the biased (overall) conversion rate as described in Equation 5. The item selection model 305 learns the unbiased conversion rate and the contrast effect using least squares regression. Once the item selection model 305 learns functions for the unbiased conversion rate \hat{r}(i) and the contrast effect \hat{b}(d(g)), the item selection model 305 selects a recommended item 122 that gives a maximum unbiased conversion rate, using the function argmax_{iϵI}_{ₜ}\hat{r}(i).

The item selection model 305 uses a basis expansion, ϕ(d(g)) to estimate the (overall) biased conversion rate \hat{r}(i, g), as described in Equation 6, where w^{T} is a learnable weight vector, rᵢ is a learnable item-dependent scalar. In some examples, the basis expansion ϕ(d(g)) is a Fourier basis expansion, but other basis expansions may be used. Given a training dataset 114 of tuples (i, g, r), where i is an item, g is a contrast group, and r is a reward value (1 if item i is converted, 0 if item i is not converted), the item selection model 305 learns \hat{r} using a linear regression algorithm. The learnable weight vector w is shared between all items and groups in the dataset. To learn the biased conversion rate function \hat{r}(i, g) at time t, the item selection model 305 constructs a |I|+M feature vector xₜ, where M is a size of the basis expansion, x_{t,i} is 1 if item i is converted at time t and 0 if item i is not converted at time t, and remaining elements are elements of ϕ(d(G_{T})). The item selection model 305 learns the parameters w^{T} and rᵢ using an ordinary least squares algorithm.

The item selection model 305 uses a upper confidence bound (UCB) algorithm (e.g. a UCB1 algorithm) to minimize the unbiased conversion rate, rather than the standard biased conversion rate. For example, the UCB1 algorithm, at each time step t, selects an item i with a highest upper confidence bound according to Equation 7, where μᵢ is an observed conversion rate for item i, Sᵢ is a number of times that item i has been recommended, Iₜ is a set of recommendable items available at time t, and C is a positive constant. In this example of Equation 7, the first term an estimate of the value, and the second term is an exploration bonus where, as time progresses, if item i is not recommended, then the exploration bonus continues to increase. Accordingly, as t goes to infinity, every item will be recommended an infinite number of times and estimates of μᵢ will converge to the true conversion rate by the law of large numbers. In some examples, instead of computing a confidence interval using Hoeffding's inequality, as in UCB1, the item selection model 305 instead computes an uncertainty in a parameter bᵢ for a given confidence interval. By increasing the confidence interval over time, for example, by choosing a confidence level of 1−1/t, the item selection model 305 guarantees that every item is eventually chosen. The item selection model 305 computes the upper confidence bound for the item-dependent parameter rᵢ by computing a t-test-style confidence interval over the regression coefficients, according to Equation 8, where i is the item number, α is a confidence level, Iₜ is the item chosen at time t, Gₜ is the group chosen at time t, Rₜ is the reward at time t, n is a number of time steps so far, and x is a matrix containing the feature vectors for each time step. The item selection model 305 then selects the recommended item 122 using the function arg max_{iϵI}CI⁺(i, a), which selects the item providing the maximum value for Equation 8.

In certain examples, one or more operations of the item selection model 305 is performed by the biased conversion rate prediction module, the unbiased conversion rate prediction module, and the item recommender module of the item recommendation system 102, as described herein. For example, the request module of item recommendation system 102 is configured to receive a set of recommendable items and a request to select, from the set of recommendable items, a group of items. For example, the item recommendation system 102 includes a biased conversion rate prediction module that is configured to determine, for each item in a set of recommendable items 120, a biased conversion rate. In certain examples, the unbiased conversion rate prediction module is configured to determine, for each possible contrast group of the set of possible contrast groups, a distance score based on features of items of the possible contrast group; and determine, for each item of the set of recommendable items and based on (1) the biased conversion rates for the item and (2) the distance score for each possible contrast group, the unbiased conversion rate for the item. In certain examples, the unbiased conversion rate prediction module is configured to determine a function that explains the biased conversion rate for each item as a function of the distance score of the respective possible contrast group that includes the item, wherein the item selection module determines the unbiased conversion rate using the function. In certain examples, the item recommendation system 102 includes an unbiased conversion rate prediction module that is configured to determine for each item in a set of recommendable items 120, an unbiased conversion rate. In certain examples, the item recommendation system 102 includes an item selection module that is configured to select the recommended item 122 from among the set of recommendable items 120. In these examples, the recommended item 122 selected by the item recommender module has a highest unbiased conversion rate of the set of recommendable items 120.

At block 430, the method 400 involves determining, using the contrast group selection model 310, a contrast group that maximizes a conversion probability of the selected recommended item 122. The contrast group selection model 310 is configured to, given a recommended item 122 selected by the item selection model 305, determine a contrast group 124 of items that includes the recommended item 122 and a predetermined number of contrast items 123 (for example, two, three, four, or other predetermined number of contrast items 123). In certain embodiments, the contrast group selection model 310 applies an algorithm that includes an asymptotic guarantee that each possible contrast group will be chosen infinitely often to ensure that a linear regression converges correctly. In certain embodiments, the contrast group selection model 310 uses a UCB1 algorithm for determining the contrast group 124. In certain embodiments, the item selection model 305 and the contrast group selection model 310 applies an Upper Confidence Bound applied to Trees (UCT) algorithm, where a UCB1 algorithm is used for both recommended item 122 selection and contrast group 124 selection. In certain embodiments, the item selection algorithm is replaced with the linear regression algorithm approach described in Algorithm 1, discussed previously. In Algorithm 1, the schedule for αₜ is a hyperparameter. As training progresses, the contrast group selection model 310 increases a confidence level to ensure sufficient explanation. In an example, the schedule

$${α}_{t} = 1 - \frac{{c}_{0}}{1 + γ t} ,$$

where c₀ and γt are adjustable. Some implementations of Algorithm 1 may control an extent to which the contrast group selection model 310 exploits contrast effects. For example, the contrast group selection model 310 can be configured to minimize effects of contrast bias when the cost (in terms of a biased regret) is low, but not when the cost is a large number of sales. To achieve this minimization of contrast bias, the contrast group selection model 310 can use an adjustable exploitation parameter, which trades off between biased and debiased algorithms, where β=0 is equivalent to the debiased UCB and β=1 is equivalent to the standard UCB. The algorithm uses a weighted average of the debiased and standard confidence bounds, with the adjustable exploitation parameter β determining the weight on each of the confidence bounds. For example, at each time step, the contrast group selection model 310 applies Equation 9, where UCB(i) of Equation 9 is defined by Equation 7 and CI⁺ of Equation 9 is defined by Equation 8. In certain examples, one or more operations of the contrast group selection model 310 are performed by the contrast group selection module of the item recommendation system 102. For example, the item recommendation system 102 includes a contrast group selection module configured to select, for the recommended item 122, from among a set of possible contrast groups that include the recommended item 122, a contrast group that will provide a greatest predicted conversion rate for the recommended item 122. For example, the contrast group selection module determines, from the set of recommendable items, a set of possible contrast groups that include the recommended item. In this example, the contrast group selection module determines, for each possible contrast group of the set of possible contrast groups, a conversion rate for the recommended item when placed in the possible contrast group. In this example, the contrast group selection module selects a possible contrast group of the set of possible contrast groups having a greatest conversion rate for the recommended item, wherein the selected contrast group comprises the selected possible contrast group.

At block 440, the method 400 involves determining a conversion outcome for presenting the selected recommended item 122 within the selected contrast group 124. For example, the recommendation model 109 selects a recommended item 122 from the set of recommendable items 120 and a contrast group 124 that includes the recommended item 122 and multiple (e.g. two) contrast items 123. The contrast group 124 is then displayed to the user in the user session. If a conversion of the recommended item 122 occurs, the recommendation model 109 receives a reward value (Rₜ) of 1, otherwise, the recommended item 122, the recommendation model 109 receives a reward (Rₜ) of 0. A conversion may be defined by the item recommendation system 102 as a purchase, click, hover, or other user interface interaction with the recommended item 122 when presented in the contrast group 124 to the user in a user interface in the user session.

At block 450, the method 400 involves adjusting parameters of one or more of the item selection model 305 and the contrast group selection model 310 based on the conversion outcome. For example, the model training subsystem 106 adjusts parameters to increase the reward. Example parameters include the learnable item-dependent scalar rᵢ of Equation 6, the learnable weight vector w of Equation 6, and the schedule for α₁. in Algorithm1. Blocks 420-450 can be repeated for a number of iterations. In certain examples, the number of training iterations is predefined.

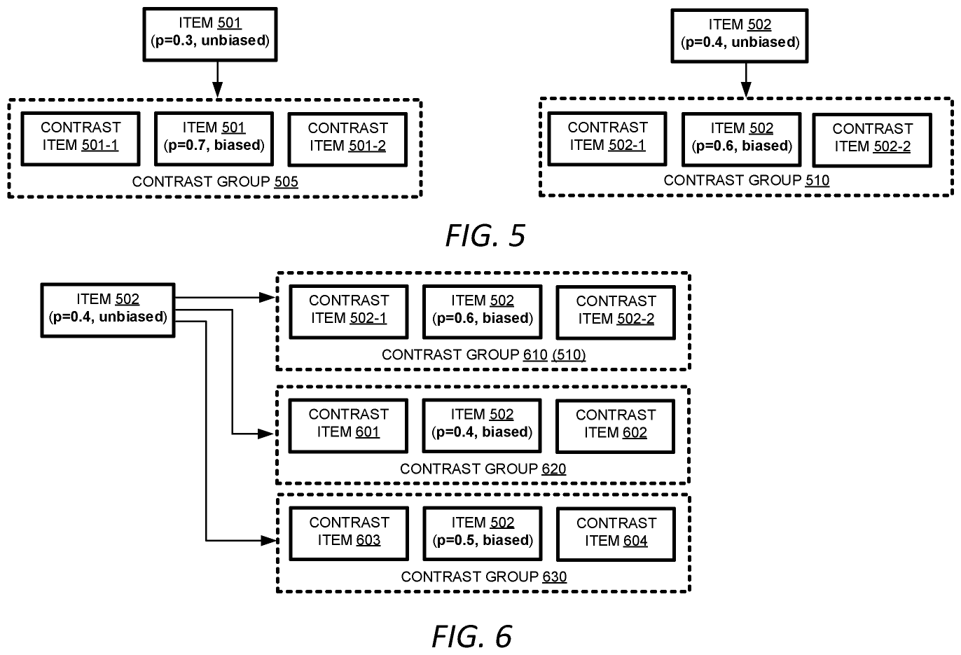

FIG. 5 depicts example illustrations of a contrast effect on recommendable items, according to certain embodiments disclosed herein. FIG. 5 illustrates this contrast effect on two example recommendable items, item 501 and item 502. Items 501 and 502 could be part of a set of recommendable items 120. As shown in FIG. 5, item 501 has an unbiased conversion rate of p=0.3 (30%) and item 502 has an unbiased conversion rate of p=0.4 (40%). The unbiased conversion rate is the probability p that a conversion (e.g. a click, an addition to a shopping cart, an addition to a wishlist, a like (on a social media post), a purchase, or other interaction with the respective item as defined by the item recommendation system 102) will occur if the item is presented to a user alone, without being in a contrast group for presentation to the user. However, when in contrast group 505, with contrast item 501-1 and contrast item 501-2, the conversion rate of item 501 increases from p=0.3 (30%) to p=0.7 (70%) when presented to the user. This increase in conversion rate of item 501 when in contrast group 505 is a contrast effect and p=0.7 is the biased conversion rate for item 501. Similarly, when item 502 is in contrast group 510 along with contrast item 502-1 and contrast item 502-2, the conversion rate of item 502 increases from p=0.4 (40%) to p=0.6 (60%) when presented to the user. This increase in conversion rate of item 502 when in contrast group 510 is a contrast effect and p=0.6 is the biased conversion rate of item 502.

In embodiments described herein, the unbiased conversion rates of items (e.g. item 501 and item 502) of a set of recommendable items 120 is not known. The item selection model 305 determines an unbiased conversion rate for each item and then selects an item having a greatest unbiased conversion rate as the recommended item 122. For example, if the item selection model 305 determined that items 501 and 502 had the greatest unbiased conversion rates of a set of recommendable items 120, the item selection model 305 would select item 502 as the recommended item 122 because item 502 has the greatest unbiased conversion rate.

FIG. 6 depicts an example illustration of a selection of a contrast group 124 for a recommended item 122, according to certain embodiments disclosed herein. For example, the item selection model 305 selects item 502 as the recommended item 122 of a set of recommendable items 120. Item 502 has an unbiased conversion rate of p=0.4 (40%). The contrast group selection model 310 receives item 502 as the recommended item 122 and selects a contrast group 124 that includes the item 502 as well as contrast items 123. FIG. 6 illustrates three contrast groups 610, 620, and 630 that the contrast group selection model 310 may select for item 502. As shown in FIG. 6, if the contrast group selection model 310 selects contrast group 610, which includes item 502 along with contrast item 502-1 and contrast item 502-2, the conversion rate of item 502 increases from an unbiased conversion rate of p=0.4 (40%) to a biased conversion rate of p=0.6 (60%). The contrast group 610 illustrated in FIG. 6 is equivalent to contrast group 510 of FIG. 5. If the contrast group selection model 310 selects contrast group 620, which includes item 502 along with contrast item 601 and contrast item 602, the conversion rate of item 502 maintains the conversion rate of p=0.4 (40%) such that the biased conversion rate is equivalent to the unbiased conversion rate. If the contrast group selection model 310 selects contrast group 620, which includes item 502 along with contrast item 603 and contrast item 604, the conversion rate of item 502 increases from an unbiased conversion rate of p=0.4 (40%) to a biased conversion rate of p=0.5 (50%). As previously discussed in FIG. 5, a contrast effect resulting from the item 502 being included within a contrast group (610, 620, or 630) contributes to any change between the unbiased and biased conversion rates.

In an example, the contrast group selection model 210 receives, as input, an indication of item 502, which has a greatest unbiased conversion rate of a set of recommendable items 120 as determined by the item selection model 305. The contrast group selection model 310 determines contrast groups 610, 620, and 630 for item 502 (the recommended item 122) and selects contrast group 610. The contrast group selection model 310 selects contrast group 610 out of contrast groups 610, 620, and 630 since contrast group 610 provides a higher biased conversion rate (p=0.6) for item 502 than contrast group 620 (p=0.4) and contrast group 630 (p=0.5) provide.

Examples of Computing Environments for Implementing Certain Embodiments

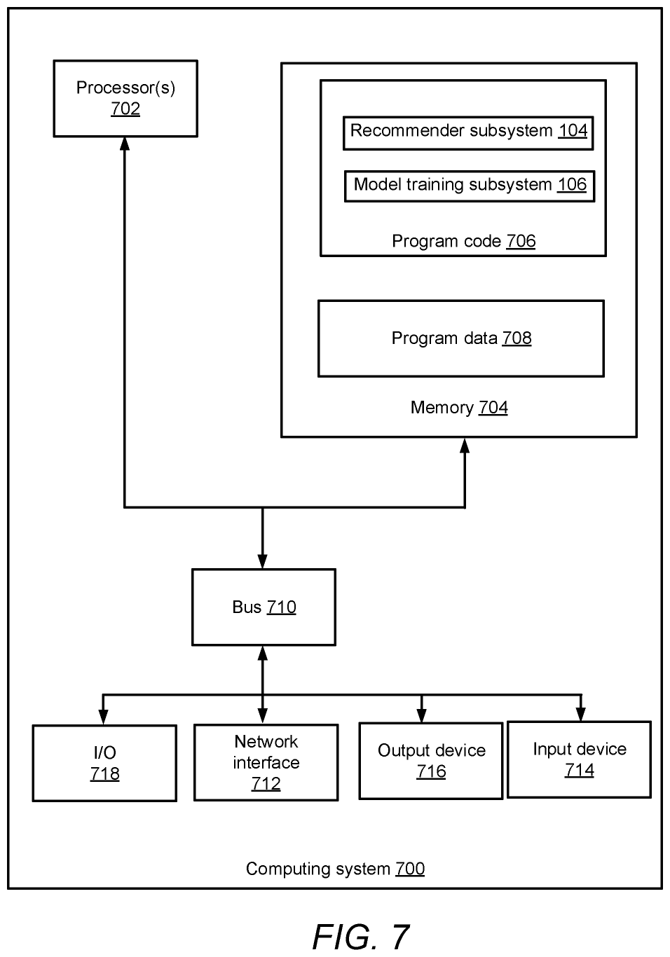

Any suitable computer system or group of computer systems can be used for performing the operations described herein. For example, FIG. 7 depicts an example of a computer system 700. The depicted example of the computer system 700 includes a processor 702 communicatively coupled to one or more memory devices 704. The processor 702 executes computer-executable program code stored in a memory device 704, accesses information stored in the memory device 704, or both. Examples of the processor 702 include a microprocessor, an application-specific integrated circuit (“ASIC”), a field-programmable gate array (“FPGA”), or any other suitable processing device. The processor 702 can include any number of processing devices, including a single processing device.

The memory device 704 includes any suitable non-transitory computer-readable medium for storing program code 706, program data 708, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory device 404 can be volatile memory, non-volatile memory, or a combination thereof.

The computer system 700 executes program code 706 that configures the processor 702 to perform one or more of the operations described herein. Examples of the program code 706 include, in various embodiments, the item recommendation system 102 (including the recommender subsystem 104 as well as the request module, the unbiased conversion rate prediction module, the biased conversion rate prediction module, the item selection module, and/or other modules of the item recommendation system 120 and the model training subsystem 106 described herein) of FIG. 1, which may include any other suitable systems or subsystems that perform one or more operations described herein (e.g., one or more neural networks, encoders, attention propagation subsystem and segmentation subsystem). The program code 706 may be resident in the memory device 704 or any suitable computer-readable medium and may be executed by the processor 702 or any other suitable processor.

The processor 702 is an integrated circuit device that can execute the program code 706. The program code 706 can be for executing an operating system, an application system or subsystem, or both. When executed by the processor 702, the instructions cause the processor 702 to perform operations of the program code 706. When being executed by the processor 702, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 704 store the program data 708 that includes one or more datasets described herein. In some embodiments, one or more of data sets are stored in the same memory device (e.g., one of the memory devices 704). In additional or alternative embodiments, one or more of the programs, data sets, models, and functions described herein are stored in different memory devices 704 accessible via a data network. One or more buses 710 are also included in the computer system 700. The buses 710 communicatively couple one or more components of a respective one of the computer system 700.

In some embodiments, the computer system 700 also includes a network interface device 712. The network interface device 712 includes any device or group of devices suitable for establishing a wired or wireless data connection to one or more data networks. Non-limiting examples of the network interface device 712 include an Ethernet network adapter, a modem, and/or the like. The computer system 700 is able to communicate with one or more other computing devices via a data network using the network interface device 912.

The computer system 700 may also include a number of external or internal devices, an input device 714, a presentation device 716, or other input or output devices. For example, the computer system 700 is shown with one or more input/output (“I/O”) interfaces 718. An I/O interface 718 can receive input from input devices or provide output to output devices. An input device 714 can include any device or group of devices suitable for receiving visual, auditory, or other suitable input that controls or affects the operations of the processor 702. Non-limiting examples of the input device 714 include a touchscreen, a mouse, a keyboard, a microphone, a separate mobile computing device, etc. A presentation device 716 can include any device or group of devices suitable for providing visual, auditory, or other suitable sensory output. Non-limiting examples of the presentation device 716 include a touchscreen, a monitor, a speaker, a separate mobile computing device, etc.

Although FIG. 7 depicts the input device 714 and the presentation device 716 as being local to the computer system 7700, other implementations are possible. For instance, in some embodiments, one or more of the input device 714 and the presentation device 716 can include a remote client-computing device that communicates with computing system 700 via the network interface device 712 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

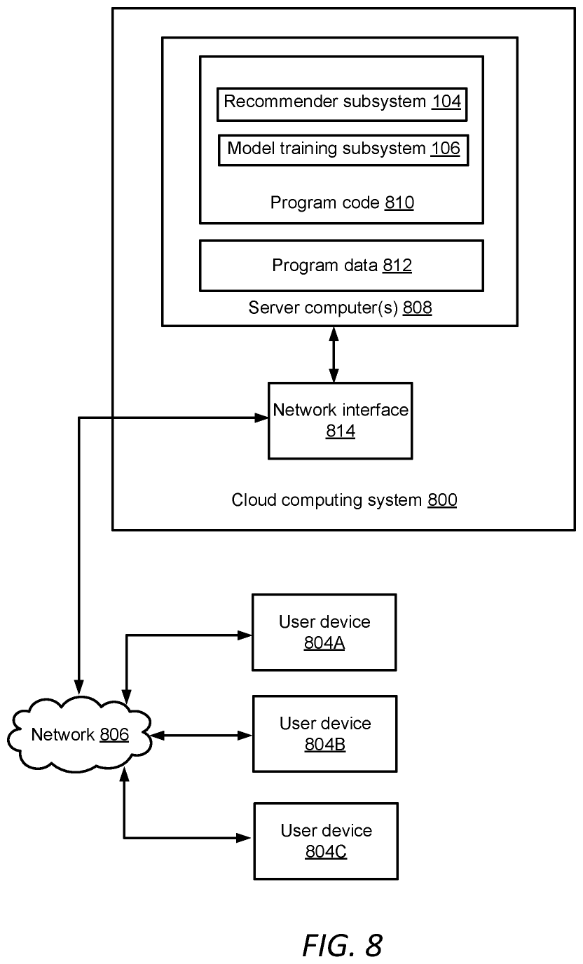

In some embodiments, the functionality provided by computer system 700 may be offered as cloud services by a cloud service provider. For example, FIG. 8 depicts an example of a cloud computer system 800 offering a service for selecting, for a set of recommendable items 120, a contrast group 124 that includes a recommended item 122 and contrast items 123, that can be used by a number of user subscribers using user devices 804A, 804B, and 804C across a data network 806. In the example, the service for selecting, for a set of recommendable items 120, a contrast group 124 that includes a recommended item 122 and contrast items 123 may be offered under a Software as a Service (SaaS) model. One or more users may subscribe to the service for selecting, for a set of recommendable items 120, a contrast group 124 that includes a recommended item 122 and contrast items 123, and the cloud computer system 800 performs the processing to provide the service for selecting, for a set of recommendable items 120, a contrast group 124 that includes a recommended item 122 and contrast items 123 to subscribers. The cloud computer system 800 may include one or more remote server computers 808.

The remote server computers 808 include any suitable non-transitory computer-readable medium for storing program code 810 (e.g., the recommender subsystem 104 and the model training subsystem 106 of FIG. 1) and program data 812, or both, which is used by the cloud computer system 800 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 508 can include volatile memory, non-volatile memory, or a combination thereof.

One or more of the server computers 808 execute the program code 810 that configures one or more processors of the server computers 808 to perform one or more of the operations that provide recommended item 122 and contrast group 124 selection services. As depicted in the embodiment in FIG. 8, the one or more servers providing the services for selecting, for a set of recommendable items 120, a contrast group 124 that includes a recommended item 122 and contrast items 123 may implement the recommender subsystem 104 and the model training subsystem 106. Any other suitable systems or subsystems that perform one or more operations described herein (e.g., one or more development systems for configuring an interactive user interface) can also be implemented by the cloud computer system 800.

In certain embodiments, the cloud computer system 800 may implement the services by executing program code and/or using program data 812, which may be resident in a memory device of the server computers 808 or any suitable computer-readable medium and may be executed by the processors of the server computers 808 or any other suitable processor.

In some embodiments, the program data 812 includes one or more datasets and models described herein. In some embodiments, one or more of data sets, models, and functions are stored in the same memory device. In additional or alternative embodiments, one or more of the programs, data sets, models, and functions described herein are stored in different memory devices accessible via the data network 806.

The cloud computer system 800 also includes a network interface device 814 that enable communications to and from cloud computer system 800. In certain embodiments, the network interface device 814 includes any device or group of devices suitable for establishing a wired or wireless data connection to the data networks 806. Non-limiting examples of the network interface device 814 include an Ethernet network adapter, a modem, and/or the like. The recommended item 122 and contrast group 124 selection service is able to communicate with the user devices 804A, 804B, and 804C via the data network 806 using the network interface device 814.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied— for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A computer-implemented method in which one or more processing devices perform operations comprising:
receiving a set of recommendable items and a request to select, from the set of recommendable items, a contrast group;
selecting the contrast group from the set of recommendable items by applying a recommendation model to the set of recommendable items, wherein the recommendation model comprises:
an item selection model configured to:
determine, for each item of the set of recommendable items, an unbiased conversion rate;
select a recommended item comprising an item of the set of recommendable items having a greatest unbiased conversion rate;
a contrast group selection model configured to select, for the recommended item, the contrast group, wherein the contrast group comprises the recommended item and one or more contrast items; and
transmitting, responsive to the request, the contrast group.

2. The computer-implemented method of claim 1, wherein determining, for each item of the set of recommendable items, the unbiased conversion rate comprises:
determining, for each item of the set of recommendable items, biased conversion rates of the item when included within each possible contrast group of a set of possible contrast groups that include the item;
determine, for each possible contrast group of the set of possible contrast groups, a distance score based on features of items of the possible contrast group; and
determining, for each item of the set of recommendable items and based on (1) the biased conversion rates for the item and (2) the distance score for each possible contrast group, the unbiased conversion rate for the item.

3. The computer-implemented method of claim 2, wherein determining the distance score comprises determining a similarity between features of each of the items of the possible contrast group.

4. The computer-implemented method of claim 2, wherein determining the unbiased conversion rate comprises determining a function that explains the biased conversion rate for each item as a function of the distance score of the respective possible contrast group that includes the item.

5. The computer-implemented method of claim 4, wherein determining the function comprises applying an upper confidence bound (UCB) algorithm.

6. The computer-implemented method of claim 4, wherein determining the unbiased conversion rate comprises determining an output of the function based on a distance score of zero.

7. The computer-implemented method of claim 1, wherein selecting the contrast group comprising the recommended item comprises:
determining, from the set of recommendable items, a set of possible contrast groups that include the recommended item;
determining, for each possible contrast group of the set of possible contrast groups, a conversion rate for the recommended item when placed in the possible contrast group,
selecting, a possible contrast group of the set of possible contrast groups having a greatest conversion rate for the recommended item, wherein the selected contrast group comprises the selected possible contrast group.

8. A system comprising:
a request module configured to receive a set of recommendable items and a request to select, from the set of recommendable items, a group of items;
a biased conversion rate prediction module configured to determine, for each item of the set of recommendable items, biased conversion rates of the item when included within each possible contrast group of a set of possible contrast groups that include the item;
an unbiased conversion rate prediction module configured to determine, for each item of the set of recommendable items based on the respective determined biased conversion rates, an unbiased conversion rate for the item;
an item selection module configured to select a recommended item comprising an item of the set of recommendable items having a greatest unbiased conversion rate; and
a contrast group selection module configured to select, for the recommended item, a contrast group comprising the recommended item from among a plurality of contrast groups that include the recommended item, wherein the selected contrast group provides a greatest biased conversion rate for the recommended item of the plurality of contrast groups.

9. The system of claim 8, wherein the unbiased conversion rate prediction module is further configured to:
determine, for each possible contrast group of the set of possible contrast groups, a distance score based on features of items of the possible contrast group; and
determine, for each item of the set of recommendable items and based on (1) the biased conversion rates for the item and (2) the distance score for each possible contrast group, the unbiased conversion rate for the item.

10. The system of claim 9, wherein determining the distance score comprises determining a similarity between features of each of the items of the possible contrast group.

11. The system of claim 9, wherein the unbiased conversion rate prediction module is further configured to determine a function that explains the biased conversion rate for each item as a function of the distance score of the respective possible contrast group that includes the item, wherein the item selection module determines the unbiased conversion rate using the function.

12. The system of claim 11, wherein determining the function comprises applying a UCB algorithm.

13. The system of claim 11, wherein determining the unbiased conversion rate comprises determining an output of the function based on a distance score of zero.

14. The system of claim 8, wherein the contrast group selection module is further configured to;
determine, from the set of recommendable items, a set of possible contrast groups that include the recommended item;
determine, for each possible contrast group of the set of possible contrast groups, a conversion rate for the recommended item when placed in the possible contrast group,
select a possible contrast group of the set of possible contrast groups having a greatest conversion rate for the recommended item, wherein the selected contrast group comprises the selected possible contrast group.

15. A non-transitory computer-readable medium having program code that is stored thereon, the program code executable by one or more processing devices for performing operations comprising:
accessing a set of recommendable items;
a contrast group from the set of recommendable items by applying a recommendation model to the set of recommendable items, wherein the recommendation model comprises:
an item selection model configured to:
determine, for each item of the set of recommendable items, an unbiased conversion rate;
select a recommended item comprising an item of the set of recommendable items having a greatest unbiased conversion rate;
a contrast group selection model configured to select, for the recommended item, a contrast group comprising the recommended item; and
transmitting, responsive to the request, the contrast group.

16. The non-transitory computer-readable medium of claim 15, wherein determining, for each item of the set of recommendable items, the unbiased conversion rate comprises:
determining, for each item of the set of recommendable items, biased conversion rates of the item when included within each possible contrast group of a set of possible contrast groups of items that include the item;
determine, for each possible contrast group of the set of possible contrast groups, a distance score based on features of items of the possible contrast group; and
determining, for each item of the set of recommendable items and based on (1) the biased conversion rates for the item and (2) the distance score for each possible contrast group, the unbiased conversion rate for the item.

17. The non-transitory computer-readable medium of claim 16, wherein determining the unbiased conversion rate comprises determining a function that explains the biased conversion rate for each item as a function of the distance score of the respective possible contrast group that includes the item.

18. The non-transitory computer-readable medium of claim 17, wherein determining the function comprises applying an upper confidence bound (UCB) algorithm.

19. The non-transitory computer-readable medium of claim 17, wherein determining the unbiased conversion rate comprises determining an output of the function based on a distance score of zero.

20. The non-transitory computer-readable medium of claim 15, wherein selecting the contrast group comprising the recommended item comprises:
determining, from the set of recommendable items, a set of possible contrast groups that include the recommended item;
determining, for each possible contrast group of the set of possible contrast groups, a conversion rate for the recommended item when placed in the possible contrast group,
selecting, a possible contrast group of the set of possible contrast groups having a greatest conversion rate for the recommended item, wherein the selected contrast group comprises the selected possible contrast group.
